(19) United States
(12) Patent Application Publication
(10) Pub. No.: US 2009/0198706 A1
(43) Pub. Date: Aug. 6, 2009

(54) System and method for managing facility location data

(75) Inventor: Stephen R. Sanders, Celina, TX (US)

Correspondence Address: DOCKET CLERK, DM/EDS, P.O. DRAWER 800889, DALLAS, TX, 75380, US

(73) Assignee: Electronic Data Systems Corporation, Plano, TX (US)

(21) Appl. No.: 12/012,355

(22) Filed: Feb. 1, 2008

(51) Int. Cl. G06F 17/30

(52) U.S. Cl. 707/100; 707/E17.001

(57) ABSTRACT

The present disclosure provides a method for managing facility location data. The method includes receiving a location data record from a first client application, validating the location data record by applying one or more validation rules to the location data record, and standardizing the location data record by converting one or more non-standard components of the location data record into one or more standardized components. The method also includes generating a standardized location data record from the standardized components, and publishing the standardized location data record to one or more subscribing applications.

### BACKGROUND OF THE DISCLOSURE

A business often needs to share its facility location data with one or more other businesses. For example, in a supply chain, a supplier has a need to let its downstream clients know a change to an existing facility location, an addition of a new facility, or temporary or permanent unavailability of a facility. A change to the facility location data records need to be communicated in a timely fashion to all the client applications that subscribe to updates to a particular facility location data record.

A facility location data record may contain a variety of fields. For example, common fields found in location data records may include an address field, a location type field, and associated client information, among others. Application of one enterprise may have facility location data records in a proprietary format that is different from formats of location data records of other enterprises.

### SUMMARY OF THE DISCLOSURE

According to one embodiment of the present disclosure, a method is provided for managing facility location data. The method includes receiving a location data record from a first client application, validating the location data record by applying one or more validation rules to the location data record, and standardizing the location data record by converting one or more non-standard components of the location data record into one or more standardized components. The method also includes generating a standardized location data record from the standardized components, and publishing the standardized location data record to one or more subscribing applications.

According to another embodiment of the present disclosure, a system is provided that includes a memory operable to store a plurality of location data records and a plurality of data security rules. The system also includes one or more processors collectively operable to implement a location data hub that is configured to receive a location data record from a client application, and to validate the location data record by applying one or more validation rules to the location data record. The location data hub is also configured to standardize the location data record by converting one or more non-standard components of the location data record into one or more standard components, to generate a standardized location data record from the standardized components, and to publish the standardized location data record to one or more subscribing applications.

According to yet another embodiment of the present disclosure, a computer program embodied on a computer readable medium and operable to be executed by a processor is provided. The computer program comprises computer readable program code for receiving a location data record from a client application, for validating the location data record by applying one more validation rules to the location data record, and for standardizing the location data record by converting one or more non-standard components in the location data record into one or more standard components. The computer program also includes the computer readable program code for generating a standardized location data record from the standard components and for publishing the standardized location data record to one or more subscribing applications.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. The terms “firewall log record manager” and “firewall log record management system” refer to a software system, hardware system, or system that combines hardware and software components that can perform management related functions on a large number of firewall log records. The two terms and their equivalents may be used interchangeably throughout the disclosure. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in accordance with a disclosed embodiment;

FIG. 2 depicts a block diagram of a networked location data hub (LDH) coupled with applications via a communication networks accordance with a disclosed embodiment;

FIG. 3 depicts a block diagram of an example of the location data hub coupled with upstream and downstream applications in accordance with a disclosed embodiment;

FIG. 4 depicts a block diagram for various modules of a location data hub in accordance with a disclosed embodiment; and

FIG. 5 depicts a block diagram of a method for managing facility location data records in accordance with a disclosed embodiment.

### DETAILED DESCRIPTION

Some enterprise applications maintain facility location data independently in multiple applications. Each system uses its own proprietary coding system for identifying facility locations. This makes it difficult for an enterprise application to share its location data with applications of other enterprises for business needs. In addition, either there are few mechanisms available for validating location data across applications or there is no validation at all.

Traditionally, there have been two approaches to exchanging the facility location data between client applications. The first approach is to directly export the entire data base from an upstream client database to a downstream client applicant database. This approach requires many point-to-point interfaces to allow all client applications that have a need to share the facility location data to do so. In addition, this approach requires that both the upstream and downstream applications to use the same database, the same application code or application program interfaces (API) at a minimum. These requirements may not be practical. The second approach is to build cross-references manually between the keys of two applications that need to share the location record data. Therefore, there is a need for a centralized application that can validate the location data input from an enterprise application, and convert the proprietary data format into a standardized format.

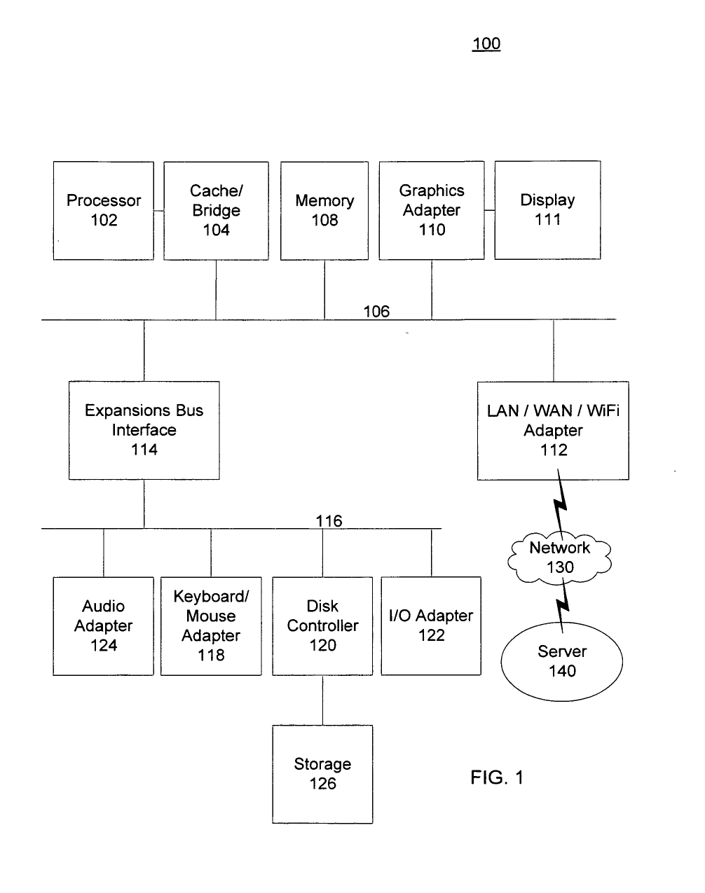

FIG. 1 through FIG. 5, discussed below, and the various embodiments used to describe the principles of the present disclosure in this patent document are by way of illustration only and should not be construed in any way to limit the scope of the disclosure. Those skilled in the art will understand that the principles of the present disclosure can be implemented in any suitably arranged device. The numerous innovative teachings of the present application will be described with reference to exemplary, non-limiting embodiments.

FIG. 1 depicts a block diagram of a general data processing system in which an embodiment of the present disclosure can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, a trackball, and a trackpointer, etc.

Those of ordinary skill in the art will appreciate that the hardware depicted in FIG. 1 may vary for particular embodiments. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

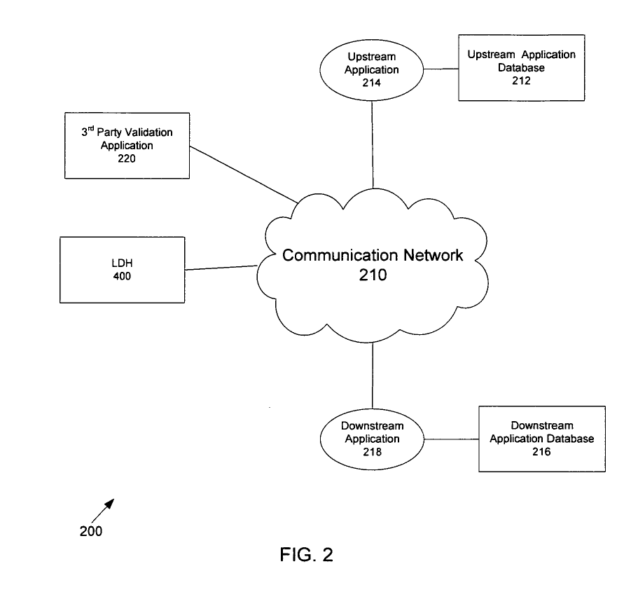

FIG. 2 depicts a block diagram of a networked location data hub (LDH) 200 coupled with applications via a communication networks 210 in accordance with a disclosed embodiment. Each application is implemented and associated with one or more data processing systems, such as data processing system 100. The networked location data hub 200 includes the communication network 210, a location data hub 400, a 3^{rd} party validation application 220, an upstream client application 214 and an associated upstream application database 212, and a downstream application 218 and an associated downstream application database 216.

The communication network 210 can be a combination of a public Internet and a private network that belongs to an enterprise and that is interconnected to the public Internet. One example of such an interconnected network scenario is a supply chain network. The communication network 210 can contain, for example, a supplier's enterprise network and one or more public IP networks so the downstream clients of the supplier chain can access their accounts on the supplier's network via the public Internet. The supplier network can also be interconnected to a network belonging to a partner such as a financial transaction partner that can deliver financial transaction service to the supplier's customers. Various applications belonging to different businesses can be connected to each other via the communication network 210.

The upstream application 214 and the associated application database 212 are providers of the facility location data records. For example, an auto parts manufacturer can have an application for managing data of various auto part facility locations to provide auto parts to its clients. The upstream application database 212 can be a location database for facility locations where auto parts may be retrieved or delivered.

The downstream application 218 and the associated downstream application database 216 are the consumers of the facility location data provided by the upstream application 214. For example, the downstream application 218 can be an application of an auto part retail chain that needs to have up-to-date information on parts supplier's facility location. The downstream client application database 216 can be a database that the auto parts retailer maintains on the auto parts of various suppliers.

In the example above, the upstream application 214, i.e., the auto part supplier's application, may have updates to its facility location from time to time. In addition, the information of which facility location has what parts also change frequently. These updates on facility location data need to be communicated to the downstream applications 212 in a timely manner.

A conventional approach to exchanging the facility location data between the upstream application 214 and the downstream application 218 is to directly export the entire data base from the upstream database 212 to the downstream applicant database 216. This approach requires many point-to-point interfaces to allow all client applications that have ad need to share the facility location data to do so. In addition, this approach requires that both the upstream and downstream applications to use the same database, the same application code or application program interfaces (API) and the same location data record format at a minimum. These requirements may not be practical.

The location data hub 400 is used to facilitate the facility location data sharing between the upstream application 214 and the downstream application 218, and can be implemented, for example, as a data processing system 100 configured to function as described herein. The location data hub 400 provides a common API for the applications to connect to a common database. The location data hub 400 can validate the syntax and semantics of a client location facility data record, using validation rules and a third party validation application 220. The location data hub 400 can standardize the client facility location data record and generate a standardized facility location data record. The standardized facility location data can serve as a reference point for various client location data records of different format associated with different applications. In addition, the location data hub 400 can provide a cross-reference between proprietary client location facility data records. The location data hub 400 can also publish the updated, standardized facility location data to-all subscribing applications.

The 3^{rd} party validation application 220 and a validation database may provide validation function and data needed to validate the location data record. The 3^{rd} party validation application 220 may have its own data base or an independent database (not shown). The location data hub 400 may use the 3^{rd} party validation application 220 and the associated database to validate the client facility data. A common 3^{rd} party location data is Postal Office database that can be used to validate whether an address in the client facility location data record is valid.

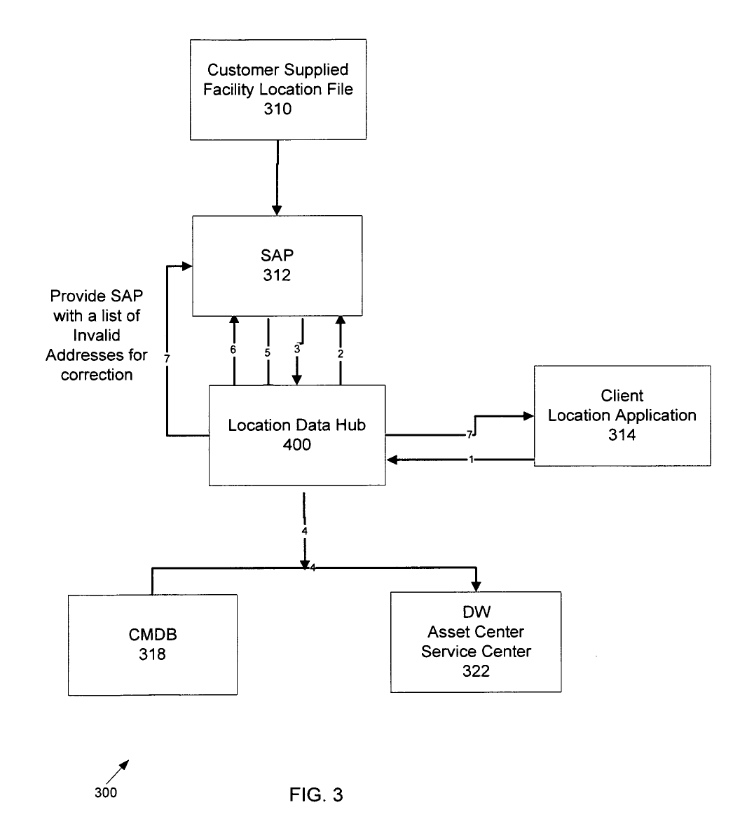

FIG. 3 depicts a block diagram of a location data hub example 300 coupled with upstream and downstream example applications in accordance with a disclosed embodiment. The LDH example 300 includes a customer supplied facility location file 310, a client location application 314, a SAP (Systems Applications and Products) application 312, a location data hub 400, and two downstream applications. The two downstream applications includes the configuration management database (CMDB) 318, and the asset center and service center 322.

The SAP 312 is a database management application that may be part of the location data hub 400 or external to it, depending on a specific system design. It provides the storage function to store the standardized location data records, data security rules and other data associated with location data hub 400. In other embodiments, other types of database management application may be used. The SAP 312 has a standard interface to the location data hub 400. In one embodiment, an XML interface is used between the SAP 312 and the location data hub 400 and other associated applications.

A standardized location data record includes a standardized location code. The standardized location code incorporates standard address components defined by international organizations such as the International Organization for Standards (ISO) and national organization such as the U.S. Postal Service. For example, the country codes are standardized by the ISO, and a state name in the U.S. is standardized as a two-letter code such as MA for Massachusetts. For some parts of a location code, there are not any standard codes. For example, there is not a standard way to define a code for a city name. For those cases, the location data hub 400 uses a consistent and uniform algorithm to generate a code to be part of the standardized location code. The standardized location code is intended to cover not only a location in a particular country such as the U.S. but also any location around the globe.

The Customer Supplied facility location file 310 is one type of input to the location data hub 400. It allows manual input into SAP 312, and then the SAP 312 sends the data to the location data hub 400. The location data hub 400, after validating and standardize the received location data record, then sends back the standardized location data record to the SAP for storage.

The client location application 314 is an example upstream application and has an API connected to the location data hub 400. It can input client facility location data via an XML interface into the location data hub 400. The upstream client application 314 may also exchange location data with other applications such as the downstream applications using the location data hub 400 as an intermediary.

Configuration management database (CMDB) 318, and digital workflow (DW) asset center and service center 322 are examples of the downstream application 218. Multiple instances of each type of application may be associated with the location data hub 400 at the same time. The client application can only subscribe to certain location data record updates or new records that it is allowed to have access to. Each of the client application may have a standard interface such as an XML interface to the location data hub 400.

An example message exchanges in the LDH example 300 can help illustrate the operations of the location data hub 400. In step 1, the client application 314 periodically provides a facility data file in the XML format to the location data hub 400. The file update can be on demand, on a fixed schedule such as once a day, or once a week or a combination of the two. The owner of the location data hub 400 is often a third party that specializes in management of client data, including the facility location data. The location data hub 400 validates and standardizes the input facility location data file that may contain many facility location data records.

The step 2 shows that the location data hub 400 sends the processed facility location data records to the SAP 312 and other instances of SAP application (not shown). In turn, the SAP 312, one instance of the SAP application, updates a local database with the processed facility location data records. The step 3 shows the SAP 312 sends the facility location data record update to the location data hub 400 to be passed on to other independent instances of location data hub 400. The step 4 shows that the downstream client application instances of CMBD 318 and instances of DW asset set and service center 322 retrieve the facility location data updates from the connected location data hub 400

The steps 5 through 7 show the operation sequence for manually input location facility data updates. The step 5 shows that the SAP 311 send the updates it received from the customer supplied facility location file 310 to the location data hub 400. The location data hub 400, as described above, validates and standardizes the updates. The validated and standardized location data records are sent to the SAP 312 for storage at the step 6. The step 7 shows that the notifications are sent to the SAP 312 to be forwarded to the source of the customer supplied facility location file 310 on those location data records that failed validation. The notifications are also sent to the client location application 314 if the location data update originated from the client location application 314.

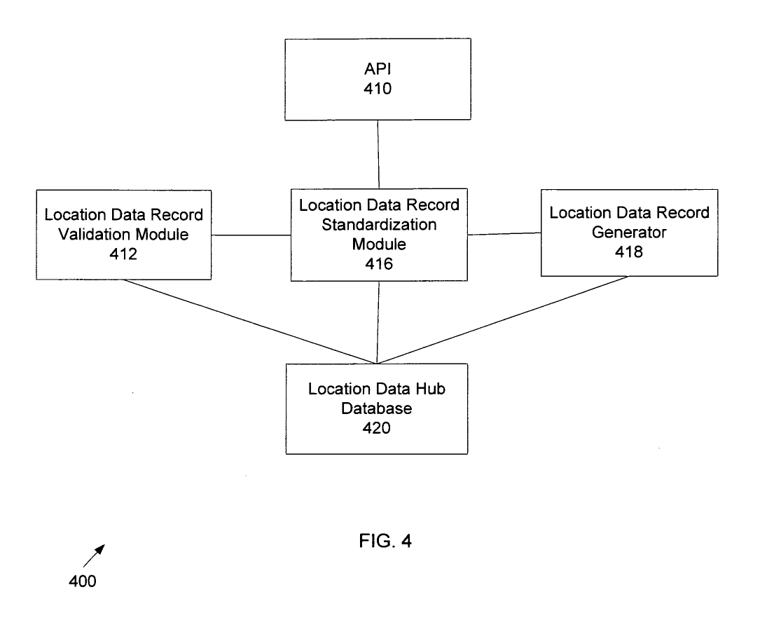

FIG. 4 depicts a block diagram of a location data hub 400 including various modules in accordance with a disclosed embodiment. In one embodiment, the location data hub 400 includes a location data record validation module 412, an API 410, a location data record standardization module 416, a location data record generator 418, and a location data hub database 420.

Location data records are stored in the location data hub database 420, shared with the client applications via the API 410 and are validated at the location data validation module 412. In one embodiment, the standardized location data record can include a standardized location code, a name field, a location type field, an address component field, an identifier field, and a related client info field. The name field may be client name, a business address or special name. The location type field may have a ship_to type, a ship_from type, or a bill_to type, among others. The standardized location code is intended to cover not only a location in a particular country such as the U.S. but also any location around the globe.

The address component field may include a number of parts such as a country part, a state or province part, a city part, and a street part. Optionally, the address component field may also include a delivery_point part. An example of the delivery_point part is a building number on a street address which may have multiple buildings sharing the same street address. Some parts of the address component can be validated and some parts of the address component can not be validated. The regular address may include a country code, a state or province name, a city name, a county name and/or a town name. The location data record may include a mandatory portion and optional portion. For example, the city name or code can be mandatory portion of an address while the county name can be an optional part. The mandatory part may be validated and the optional parts may not be validated.

The API module 410 can provide a program interface to external applications such as upstream applications 314 and downstream client application 318 and 322. The API, in one embodiment, is a standard XML interface. The standard API can simplify the communication between the location data hub 400 and other applications such as the downstream application 318 and 322 and the upstream applications 310, 312, and 314. The API can also provide a queue to hold location data record updates for the downstream client applications to retrieve.

The location data validation module 412 can validate an input location data record. The validation can include checking whether the address is valid and whether the location data is complete. Some parts of a location data record are mandatory and some are optional. For example, a city part of an address component is mandatory while county part of the address may be optional. A street address may be mandatory while delivery points of a street address may be optional. The mandatory portions of the location data records are checked. The validation can often be performed using a third party validation application. One example of validation application is US. Postal address validation that can check whether an input address exists. The location data validation module 412 can also send a notification to an outside client application on a location data record that has failed the validation.

The location data standardization module 416 may add missing part and convert the non-standard component into a standard component. Some parts of location data record may be mandatory for some applications or some clients but optional for some other clients or applications. For example, the county portion in an address may be optional in some cases and mandatory in some other cases. The standardization module may fill in the missing part if it is mandatory but missing from the location data record. For example, a 3^{rd} party application may provide a corresponding county name if a city name is provided.

The location data standardization module 416 may standardize the input location data record. For example, the state or province part or a city part of the address component is provided but is not standardized. For example, the standardization module 416 can standardize an input location data record by converting a variable-length part into a fixed length part. For example, in one embodiment, a city name are converted into a city code of three characters long while the city name in the original input may have a variable length.

The location data record generator 418 may generate standardized part of address. As described earlier, a standardized location code incorporates standard address components defined by international organizations such as the International Organization for Standards (ISO) and national organization such as the U.S. Postal Service. For example, the country codes are standardized by the ISO, and a state name in the U.S. is standardized as a two-letter code such as MA for Massachusetts. For some parts of a location code, there are not any standard codes defined. For example, there is not a standard way to define a code for a city name. For those cases, the location code generator 418 uses a consistent and uniform algorithm to generate a code to be part of the standardized location code. Examples of the standardized part of a standardized location code generated by the location code generator 418 may include a city code and a county code. The location data record generator 418 may assemble standardized components into a standardized location data record and store the record into a database.

The location data hub database 420 can be a local database. In another embodiment, it can be an external database such as the SAP database 312. FIG. 4 shows an internal database 420. The database 420, according to some embodiments of the current disclosure, can be implemented on a combination of the memory 108 and the data storage 126 of the data processing system as shown in FIG. 1. The location data hub database 420 can be configured to store and manage the facility location data records, data security rules, and address abbreviation records. The database 420 can be implemented using a relational database, an object-oriented database, or a future database technology. The database 420 may be centrally located or distributed across multiple geographical areas, depending on the system design.

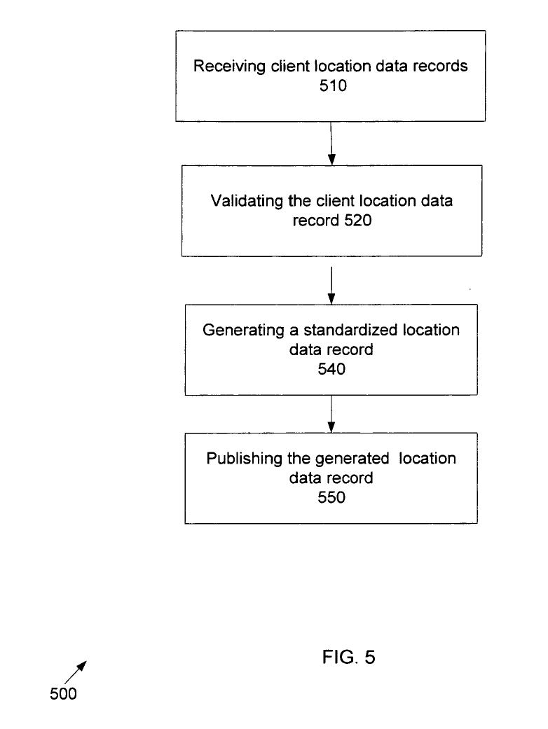

FIG. 5 depicts a block diagram of a method 500 for managing location data records in accordance with a disclosed embodiment. The method 500 may include receiving client location data records at 510, validating the client location data record at 520, generating a standardized location data record at 530 and publishing the generated location data record at 540.

The step of receiving client location data records at 510 can include receiving the location data record and extracting some parts of the location data record such as the address component. The location data record may be received via a manual input source, a program interface or a data import application.

The step of validating the client location data record at 520 can include parsing the record into individual components, validating each component, and augmenting a component if there is a need. Parsing the location data record can include checking syntactical errors, and breaking the input data record into base units. Checking syntactical errors may include applying syntax rules and grammar and identifying the part of the location data record that violate some of the syntax rules. For example, one syntax rule may stipulate that a leading character for a state or city name must be an alphabetic character. Breaking the input location data record into base units can include extracting a syntactical word separated by an allowed separator such as a white space or a comma.

Validating the parsed components of the input location data record can include applying various validation rules, invoking a third party validation application, and generating a notification in case of a validation failure. Applying a validation rule can include separating a mandatory part of the location data record from a non-mandatory part, deciding on and apply an applicable validation rule on the mandatory part. Applying the applicable rule may involve retrieving the validation rule from a local or external database and applying the validation rule to the data record component. Invoking the third party validation applicant can take place either in place of or in addition to applying the validation rule. Invoking the third party validation application can involve calling a published interface of the third party validation application, or sending a request to a proxy. Generating the notification can involve creating proper fields for an alarm or event and sending the alarm or event to the concerned parties such as an upstream application that originally sent the location data record. Generating the notification can also involve creating a log record for the validation failure. The validation may proceeds in face of a non-fatal validation failure.

The step of generating a standardized location data record at 530 may include converting a non-standard location data record component into a standardized component, augmenting the data record as needed, eliminating unneeded part from the data record, and creating a unique global identifier and one or more cross references for the standardized location record. Converting the non-standardized component into the standardized component can include generating a standard location code from an input location name. For example, different entries for a state, such as the fully-spelt name “Massachusetts”, a dotted abbreviation “M.A.” or other variants can all be standardized on “MA”. Similarly, a city name of a single word or multiple words can be converted into a city code of a fixed length.

Augmenting the location data record component can include identify a missing part in the location data record component and generating the missing part. Identifying the missing part may involve applying one or more rules to distinguish a required part from an optional part. For example, a delivery point or county name that identifies a specific building on a street address or a county that identifies a county where the city is located, may be mandatory for some enterprises while they may be operational for some other enterprises. Generating the identified missing part may involve querying a database such as postal database or sending a request to an outside application such as a third party validation application. Eliminating the unneeded part can include identifying a part in the input location data record component that is not needed and discarding it in generating the standardized location data record.

Creating the unique global ID and one or more cross references for the location data record can includes creating the unique ID for the standardized location data record, and associating the global ID with one or more local identifiers for the same location data record to create a cross reference. Creating the cross reference also includes supporting a query of the standardized location data record by a client application using any one of the local identifiers or the global identifier. Supporting the query of the standardized location data record also includes supporting queries across different languages. For example, a query for a location data record in German may result in a location data record in English, if the user so desires.

The step of publishing the generated location data record at 540 may include identifying one or more subscribing applications, updating the location data record with the newly build location code, storing the updated location data record in the database, and sharing the updated location data record with one or more identified subscribing applications. Identify one or more subscribing application can involve applying one or more data security filtering rules associated with the location data record. For the data security and integrity, only some specified downstream applications can receive the updated location data record. There may be security rules associated with each location data record that specify which client application has what type of access to the location data record updates.

Updating the location data record can involve updating an existing standardized location data record or creating a new standardized location data record with the location code generated through the preceding steps. Storing the updated location data record can involve storing the updated location data record in an external or internal database. Sharing the updated location data record can involve sending the updated location data record to one or more subscribing application or placing the updated location data record at a known location such as a message queue for the subscribing application to retrieve.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

This document shares some common subject matter with, but is otherwise unrelated to, U.S. patent application Ser. No. ______ (Attorney Docket Number 82-07-33), filed concurrently herewith, which is hereby incorporated by reference in its entirety.

It is important to note that while the disclosure includes a description in the context of a fully functional system, those skilled in the art will appreciate that at least portions of the mechanism of the present disclosure are capable of being distributed in the form of a instructions contained within a machine usable medium in any of a variety of forms, and that the present disclosure applies equally regardless of the particular type of instruction or signal bearing medium utilized to actually carry out the distribution. Examples of machine usable or machine readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for managing facility location data, comprising:
receiving a location data record from a first client application;
validating the location data record by applying one or more validation rules to the location data record;
standardizing the location data record by converting one or more non-standard components of the location data record into one or more standardized components;
generating a standardized location data record from the standardized components; and
publishing the standardized location data record to one or more subscribing applications.

2. The method of claim 1, further comprising storing the standardized location data record in a location data hub database.

3. The method of claim 1, wherein validating the location data record comprise checking a validity of an address component of the location data record using a third party validation application and a location database.

4. The method of claim 1, further comprising providing a web service for the first client application to exchange the standardized location data record with a second client application.

5. The method of claim 1, wherein standardizing the location data record comprises:
identifying the one or more non-standard address components;
converting the identified non-standard address components in the location data record into one or more standardized address components
identifying one or more missing parts in an address component; and
creating the identified missing components.

6. The method of claim 5, wherein creating the identified missing parts comprises creating one or more of a county, a city, a province, and a district in the standardized location data record.

7. The method of claim 5, wherein converting the non-standard component comprises converting a non-standard city abbreviation into a standard city abbreviation.

8. The method of claim 1, wherein generating the standardized location record comprises generating a unique global location identifier for the standardized location data record.

9. The method of claim 8, wherein generating the standardized location record comprises generating a cross reference between the unique global location identifier and one or more local location identifiers for the location data record.

10. The method of claim 8, wherein publishing the standardized location data record comprises:
identifying the one or more subscribing applications by applying one or more data security filtering rules; and
sending the standardized location data record to the identified subscribing applications.

11. An system for managing facility location data, comprising:
a memory operable to store a plurality of location data records, a plurality of standard abbreviations, and a plurality of data security rules;
one or more processors collectively operable to implement a location data hub configured to:
receive a location data record from a client application;
validate the location data record by applying one or more validation rules to the location data record;
standardize the location data record by converting one or more non-standard components of the location data record into one or more standard components;
generate a standardized location data record from the standardized components; and
publish the standardized location data record to one or more subscribing applications.

12. The system of claim 11, wherein the standardized location data record includes a name field, an address component field, a location type field, a global identifier field, and an associated client information field.

13. The system of claim 12, wherein the system is coupled to a third party address database and a third party validation application to validate the location data record and the third party address database is a postal address database.

14. The system of claim 11, wherein the location data hub is configured to send a notification to the client application in case of a failure in validating the location data record.

15. The system of claim 11, wherein the location data hub is configured to receive the location data record from one of a manual input source and a data export application.

16. The system of claim 11, wherein the location data hub is configured to map a unique global identifier associated with the standardized location data record to one or more local identifiers associated with the received location data record and to map a first one of the local identifiers to a second one of the local identifiers.

17. The system of claim 11, wherein the address component of the location data record has a variable length.

18. The system of claim 11, wherein the location data hub is configured to select the subscribing applications by applying one or more data security rules that specify whether one of the subscribing application is allowed to access the location data record.

19. A computer program product encoded on a computer readable medium and operable to be executed by a processor, the computer program comprising computer readable program code for:
receiving a location data record from a client application;
validating the location data record by applying one more validation rules to the location data record;
standardizing the location data record by converting one or more non-standard components in the location data record into one or more standard components;
generating a standardized location data record from the standard components; and
publishing the standardized location data record to one or more subscribing applications.

20. The computer program product of claim 19, wherein the computer program further comprise computer readable program code for
an API coupled with a third party validation application;
an location data record validation module configured to check a syntax of the location data record and validate the location data record against a standard database; and
a location data record generator configured to generate standardized location data records.
